(19) United States
(12) Patent Application Publication
(10) Pub. No.: US 2023/0237032 A1
(43) Pub. Date: Jul. 27, 2023

(54) ON-DEMAND INGESTION OF RECORDS FROM A STAGING STORAGE INTO A PRIMARY DATABASE

(71) Applicant: salesforce.com, inc., San Francisco, CA (US)

(72) Inventors: Osvaldo Rene CANEL LOPEZ, Weston, FL (US); Michael DANDY, San Francisco, CA (US); Michael STARUKHIN, Parkland, FL (US)

(73) Assignee: salesforce.com, inc., San Francisco, CA (US)

(21) Appl. No.: 17/586,541

(22) Filed: Jan. 27, 2022

(51) Int. Cl. G06F 16/22; G06F 16/25; G06F 16/245

(52) U.S. Cl. CPC G06F 16/22; G06F 16/258; G06F 16/245

(57) ABSTRACT

A method of a data manager for a database management system having a primary database and a staging storage includes receiving a request including identifying information for a set of records that have been sent to the database management system for storage, searching the staging storage for the set of records using the identifying information, and storing the set of records into the primary database prior to a scheduled storage for the set of records based on a general process for ingesting records sent to the database management system for storage in the primary database, in response to the request and to the set of records matching the identifying information.

### TECHNICAL FIELD

One or more implementations relate to the field of database management; and more specifically, to a process for on-demand processing of records that are stored in a staging storage while awaiting ingestion by the database management system.

### BACKGROUND ART

Cloud computing services provide shared network-based resources, applications, and information to computers and other devices upon request. In cloud computing environments, services can be provided by servers to users' computer systems via the Internet and wireless networks rather than installing software locally on users' computer systems.

Cloud computing systems can be used to host services for such as applications as online ordering or products, services, and similar items. Such services can utilize databases that are managed by database management systems to store data (e.g., received orders). The data received from these services can be in high volume and processed in real time. The process of receiving and storing the data as a set of records is referred to herein as “data ingestion.” Data ingestion is typically performed in real time. In the example of an online ordering services, as orders are processed, electronic messages are typically transmitted to confirm receipt of the orders. These confirmation messages typically include order numbers that enable customers track their orders.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a diagram of a system that supports on-demand record ingestion, according to some implementations.

FIG. 2 is a diagram of a time line for an example case for ingesting records according to some implementations.

FIG. 3 is a diagram of a database management system including staging storage, and on-demand processor, and query processor for providing on-demand ingestion, according to some implementations.

FIG. 4 is a flowchart of a process for processing a request for on-demand ingestion, according to some implementations.

FIG. 5 is a flowchart of a process for processing a query including a staging storage, according to some implementations.

FIG. 6A is a block diagram illustrating an electronic device according to some example implementations.

FIG. 6B is a block diagram of a deployment environment according to some example implementations.

### DETAILED DESCRIPTION

The following description describes implementations for the on-demand ingestion process and system. The on-demand process and system can enable applications and programs outside of the database management system to request that a set of records be immediately processed, which moves the records ahead in the scheduling for ingestion. The on-demand ingestion process and system can further support query or search functions that enable the identification specific records that are being stored in a staging storage while awaiting ingestion. The on-demand ingestion process and system can enable a search of records in the staging storage using any level of granularity, for example, supporting the matching against the fields of the records by implementing an indexing process for the records that are stored into the staging storage.

The on-demand ingestion process and system utilize a staging storage, also referred to as a shock absorber, to connect two systems, a producer and a consumer, in a scenario where the producer is capable of generating data at a throughput level which is impossible for the consumer to handle. This throughput pattern requires breaking the hard coupling between the producer and the consumer by temporarily storing the data in a staging storage that is able to handle the throughput of the producer and asynchronously ingest the data into the consumer system. One important limitation of this pattern is that data won't be available on the consumer system at the rate it is generated in the producer. The lag time between the moment when a set of records are generated by the producer and the moment when the record is available in the consumer is proportional to the difference in throughput between the two systems. A ‘set,’ as used herein refers to any positive whole number of items including one item. This limitation has a disruptive impact on the user experience for use cases where users would like to access certain records after a short period of time of being generated. Similarly, producer applications that seek to access records at the consumer database management system that have not been ingested can suffer performance slowdowns.

The on-demand ingestion process and system solve these issues by allowing users and/or applications to perform on-demand ingestion operations (e.g., search or query operations) on the data residing in the staging storage in order to locate data of interest. The on-demand ingestion process and system also enable users and/or applications to trigger synchronous data ingestion operations for identified sets of records from the staging storage into the consumer. The on-demand ingestion process and system solve the previously mentioned issues for use cases where users or applications attempt to access certain records shortly after they were generated and sent to the consumer, by allowing the user or application to find the records, ingest them into the consumer system and seamlessly act on them like they were there all the time since its generation.

A use case example is of an Order Management System (OMS) as a consumer system, is provided herein for sake of illustration. The OMS can be implemented as an online transaction processing (OLTP) system, receiving orders from one or multiple Store Front System(s) (SFSs), i.e., producer systems. In this scenario the SFSs can capture orders from shoppers at a much higher throughput than the OMS can ingest them. The reason being is that an order encompasses multiple aspects, for example: items ordered, discounts applied, shipping information, tax information, payment information, customer information, product information, and similar information. As a result, the normalized data model of an order is composed of many tables; hence inserting an order into a relational database management system (RDBMS) backing up the OMS is a very expensive operation. A very common use case for an OMS is for a user, either directly or via a service agent, to modify an order right after it was placed, so the user can correct some sort of a mistake, for example a wrong size/color ordered, missed to apply a coupon at check out, wrong delivery address, or similar issue. The staging storage uses a non-structured query language (SQL) database or similar storage structure. Once an order is received the staging storage or related functions serializes the order and extracts some other information to be indexed and inserts all the data in a single record. The extra information indexed is required to support the searching of the records, which, for example, could be the order number, the phone, and email address of the shopper, or similar information. As used herein, a ‘record’ refers to any data structure capable of storage in a database including tables, or similar data structures. The on-demand ingestion process and system can emit events as a result of the insertion of orders or similar records into the staging storage. This enables other systems to know that new orders or other records have been received.

Implementing the on-demand ingestion process and system involves the implementation of two different data flows between the staging storage and the database management system (e.g., an OMS) for synchronous and asynchronous record ingestion flow. The asynchronous path is the process for most of the records (e.g., orders), its main purpose is to insert the majority of the records (e.g., orders) into a primary database managed by the database management system (e.g., the OMS DB). The asynchronous path is implemented via a process that listens for the events emitted by the staging storage. Once the number of events reaches a certain threshold it queries the staging storage, which is a Non-SQL database to get the order records, and after some validations it converts the order records from the serialized format into INSERT statements to be executed against the primary database (e.g., the OMS RDBMS). Using a bulk strategy for the INSERT statements makes record data insertion more optimal.

The asynchronous process has a built in self-throttling mechanism to prevent over loading the primary database (e.g., a RDBMS DB) by trying to insert too many records in a given period of time. There are multiple strategies for implementing this self-regulatory mechanism. The self-regulatory mechanism can be getting a feedback signal from the primary database (OMS DB), e.g., a RDBMS DB central processing unit (CPU) level feedback signal, or by aiming to maintain a constant throughput, or by a similar mechanism.

Synchronous record ingestion flow is the path where the on-demand ingestion process comes into play. There are several different innovations on this synchronous record ingestion path. The synchronous path can be triggered by a user or application via a user interface (UI), application programming interface (API) or similar interface that provides a way for a user or application (e.g., a shopper or service agent) to configure predefined filters so they can locate specific records (e.g., specific orders). The search will execute queries both systems, i.e., the primary database (e.g., the OMS DB) and the staging storage, and merge the result to be presented as a single result to the requesting user or application so that from the stand point of the requester there is no difference where the requested records (e.g., orders) are located. Further, the UI/API provides a way to get a set of records (e.g., a set of orders) ingested. Under the hood on-demand ingestion process and system detects if the identified records are already in the primary database or not, and in case they are not, the on-demand ingestion process and system will automatically ingest the records (e.g., a set of orders) into the primary database and respond to the request with the requested records. Once the records have been ingested they are removed from the staging storage data repository.

Thus, the on-demand ingestion process and system provide several advantages over the prior art. The on-demand ingestion process and system provide the ability to locate records in the staging storage repository based on user defined filter criteria, the ability to present a combined list of records to the user, the ones existing in the primary database and the ones existing in the staging storage, and the ability to ingest the records from the staging storage repository into the primary database on-demand.

In some implementations, the processes of the on-demand ingestion process and system are triggered upon receiving a request. The request can have a payload that includes a plurality of data items pertaining to a data object or similar set of records. The request can be received from a user or application using a UI or API where the user or application is executed by a first client device. An identifier associated with the data object or set of records is generated and information including the data items is obtained from the request without parsing the request to obtain the individual data items. The information including the data items is stored in association with the identifier in the staging storage, where the staging storage is not a relational database. The data object or similar records can be queried in the staging storage using the identifier while processing of the records into the primary database awaits completion. Further, the records are indexed such that the records can be searched or queried on indexed fields or values in the records.

In some example implementations, a set of records or a data object includes, represents or corresponds to an order. An order can include any number of data items that together define the order. The relationship among the data items may be represented via a variety of data models or data structures. The payload of the set of records can include any number of fields and data items in a variety of different formats.

To facilitate efficient access to the records, data object, or associated data items, the on-demand ingestion system may store the payload or other aspects of the records in the staging storage without further processing of the payload. The on-demand ingestion process and system enables the data items of the payload to be accessed before processing of the records into the primary database is complete.

In some implementations, the records and identifiers for the records or identifiers for data items of the records are generated by the staging storage or associated functions, and the records or data items await to be ingested (i.e., stored) in association with the identifier in a primary database, where the primary database is a relational database that supports SQL queries. Specifically, in the ingestion the payload of the records can be parsed to obtain the individual data items and the individual data items may be stored in the primary database. The processing of the payload and storing of the data items in the primary database may be performed by a background process as part of the aforementioned asynchronous path. By storing the individual data items in a primary database, the advantages of a relational database or similar SQL capable database can be leveraged to provide efficient querying capabilities.

In some implementations, after the records including data items are stored in association with the identifier in the primary database, the records, data items, and associated identifier can be deleted from the staging storage. The deletion of the records, data items, and identifier can be performed by a background process. The records and data items can then be accessed from the primary database by querying the identifier, the values of the data items, or other related information in the primary database.

In some implementations, a customer or service agent submits a query that includes the identifier. For example, the query may be submitted via an application programming interface (API) via the first client device or a second client device. The query is processed to obtain the identifier from the query, and the identifier is used to access information pertaining to the data object. Specifically, it is determined whether the identifier obtained from the query is in the staging storage. One or more of the data items associated with the identifier may be retrieved from the staging storage according to a result of determining whether the identifier obtained from the query is in the staging storage. More particularly, if the identifier is in the staging storage, the data items may be retrieved from the staging storage. However, if the identifier is not in the staging storage, the data items may be retrieved from the primary database.

In some implementations, a separate data structure is used by the on-demand ingestion system to determine whether to retrieve information associated with a set of records, data object, or data items, from the staging storage or the primary database. Specifically, after the information corresponding to the records, data object, or data items are stored in the staging storage, the corresponding identifier or indexing information can be stored in the separate data structure (e.g., a cache) to indicate that information associated with the records, data object, or data items are stored in the staging storage. Thus, the on-demand ingestion system can determine whether an identifier obtained from a request, query, or similar operation is in the staging storage by ascertaining whether the identifier is in the data structure. In this manner, the on-demand ingestion system may identify the data store from which information pertaining to a record, data object, or data items can be retrieved.

After the records, data objects, data items, and/or identifier are stored in the primary database, the identifier can be deleted from the data structure to indicate that the information associated with the records, data object (e g, order), or data items is now stored in the primary database. The deletion of identifiers from the data structure can be performed by a background process.

The staging storage provides a buffer such that in peak times, when records (e.g., orders) come in at a very fast rate and need to be ingested into the database system, the staging storage provides a place to store the records until ingested. The on-demand ingestion system also makes the records, data objects, and data items in the staging storage accessible. For example, a customer can submit an order and subsequently wish to modify or cancel the order. To provide a good customer experience, it is desirable to enable a customer or service agent to access a recently placed order. Creating and processing an order in a complex system can be very resource intensive and a time-consuming process. Specifically, saving data for every order into a relational database can take a significant amount of time and consume a significant amount of central processing unit (CPU) resources. As a result, a significant amount of time can elapse between the time the customer places an order and the time it is available in the primary database.

To solve this issue, using this example, the order data is first saved to the staging storage, which is not a relational database, enabling data to be “written” more quickly than to a relational database. The order data can then be saved to a primary database that is a relational database. Upon receipt of a query or similar operation including an order identifier or similar information to locate an order, the on-demand ingestion system can access the order in the staging storage until it is available in the primary database or can force the ingestion of the order into the primary database.

In one example, a user submits an order via a web site and realizes subsequently that the submitted order includes an error. This would normally require an administrative intervention to correct (e.g., by contacting a customer service representative). The implementations support the user sending a query, request, or other operation to the on-demand ingestion system to make corrections. The user can submits a request with the order number or other identifier. Alternatively, the user can submit search criteria to identify the records for the order. In some implementations, the on-demand ingestion system determines whether the order number is in an order cache or similar data structure. If the order number is in the order cache, then the system queries a non-relational database (i.e., the staging storage) to retrieve the order using the order number. However, if the order number is not in the cache, the on-demand ingestion system queries a relational database (i.e., the primary database) to retrieve the order.

In one case based on this example, the on-demand ingestion system determines that the order number is in the cache, retrieves the order from the non-relational database (i.e., the staging storage) and provides the order to the user for possible modification. If the user modifies the order, then the updated order can be sent back to the on-demand ingestion system and saved to the non-relational database (i.e., the staging storage). The on-demand ingestion system subsequently saves the modified order to the relational database (i.e., the primary database). After the order is saved to the relational database, the system deletes the order from the non-relational database and the order number from the cache.

In other cases, the user can identify the order with a search request with as set of values that match data items of the orders. The on-demand ingestion system can check wither the data items are indexed and search the index for the records and retrieve them from the staging storage. In some implementations, the user can request the ingestion of the records which are identified by matching values/fields an identifier (e.g., an order number) or similar information. Where the records are ingested on demand, this can facilitate more robust operations that rely on the primary database being a relational database.

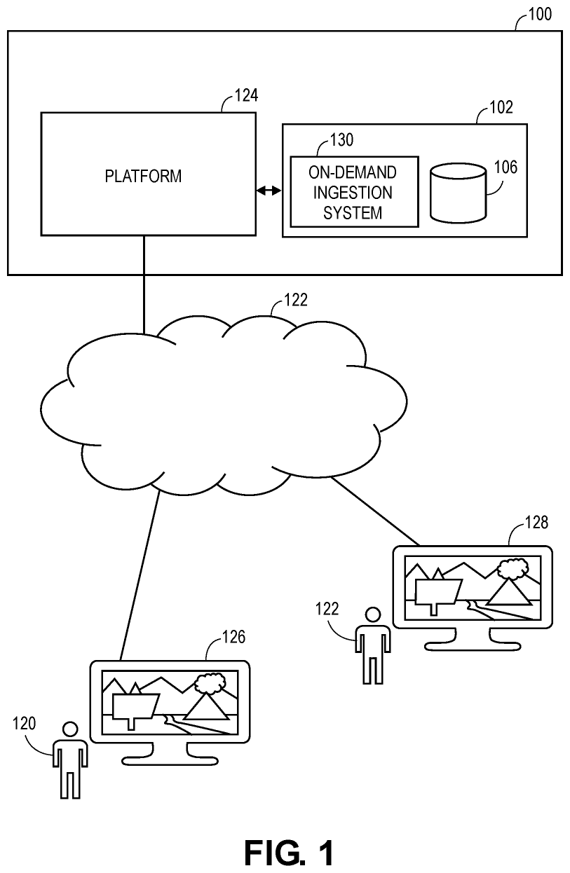

FIG. 1 is a diagram of one example of an on-demand ingestion system. The on-demand ingestion system 130 can be a set of functions in which data ingestion can be performed, in accordance with some implementations. The on-demand ingestion system 130 can be a part of a database system 102 or similar consumer system. The database system 102 can include a variety of different hardware and/or software components that are in communication with each other. In the non-limiting example of FIG. 1, the database system 102 includes any number and variety of storage resources 106. The storage resources 106 can include the primary database, staging storage, and similar data repositories.

The database system 102 can be hosted in a cloud computing environment 100 or similar computing environment composed of any number of computing devices such as a set of centralized or distributed servers and similar hardware and software resources. The cloud computing environment 100 can also host a platform 124 that hosts any type or variety of applications that can support clients as well as make use of the resources of the database system 102.

The storage resources 106 can be configured to store and maintain relevant data and metadata used to perform the processes and techniques disclosed herein, as well as to store and maintain relevant data and/or metadata generated by the techniques disclosed herein. Storage resources 106 can further store computer-readable instructions configured to perform some of the processes and techniques described herein including the processes of the on-demand ingestion system 130. In some example implementations, storage resources 106 can store records (e.g., order information) in databases, which may be generated, updated, and accessed by the on-demand ingestion system and applications of the platform 124. Storage resources 106 can include a variety of data stores, repositories, and/or caches that can be organized in any configuration and have any size or number.

In some implementations, the on-demand ingestion system 130, platform 124, or database system 102 can be configured to store user profiles/user accounts associated with users of these systems. Information maintained in a user account of a user can include or indicate credentials of the user. In some implementations, the users can be associated with tenants of the platform 124 or cloud computing environment 100, which can be a multi-tenant system. Credentials of the user can include a username and password that are associated with a set of permissions that govern what resources and data the user has access to in the cloud computing environment 100, platform 124, or database system 102. The information for the user tracked by the database system 102 or on-demand ingestion system 130 can also include order numbers or similar record identifiers of orders or records that have been submitted by the user to the database system 102.

Client devices 126, 128 can be in communication with the cloud computing environment 100, platform 124, or database system 102 via a network 122. The network 122 can be the Internet. In another example, network 122 comprises one or more local area networks (LAN) in communication with one or more wide area networks (WAN) such as the Internet.

In some implementations, the network 122, clients 126, 128, and additional electronic devices and systems such as multi-tenant databases can all be considered part of the cloud computing environment 100. The resources of the cloud computing environment 100 can be associated with a set of network domains, such as www.salesforce.com and each can be controlled by a data provider associated with the network domain. A user of client computing device 126 can have an account at a web site or platform 124 such as Salesforce.com®. By logging into this account, the user can access the various services provided by the platform 124, including, for example the database system 102, which could be configured to support an online ordering service and an order querying service or similar services either as part of the platform 124 or separately hosted by the cloud computing environment 100 and serviced by the database system 102.

In some implementations, users 120, 122 of client devices 126, 128 can access services provided by cloud computing environment 100 by logging into the platform 124. More particularly, client devices 126, 128 can log into platform 124 via an application programming interface (API) or via a graphical user interface (GUI) using credentials of corresponding users 120, 122, respectively.

For example, a user 120 can log into their account using client device 126 to submit an order via the platform 124. User 122 can be a customer service employee of Salesforce that submits an order query via applications hosted by the platform 124 using client device 128 in response to a phone inquiry by user 120. Examples of devices used by users include, but are not limited to a desktop computer or portable electronic device such as a smartphone, a tablet, a laptop, a wearable device, e.g., an optical head-mounted display (OHMD) device, a smart watch, or similar electronic devices.

In some implementations, the platform 124 provides an order processing system that facilitates processing of orders. The order processing system can submit the received orders to the database system 102 where the received orders can be serialized, indexed, and stored in a staging storage 106 by the on-demand ingestion system 130. During the processing of orders, the on-demand ingestion system system 130 saves order information or similar records so that they can be accessed by a user (e.g., a customer or customer service representative) prior to ingestion with the primary database 106. The database system 102 can include a number of different components that store received records (e.g., order information) to facilitate efficient record retrieval, modification, or cancellation. Communication among components of the database system 102 can be supported by any combination of networks and interfaces, communication protocols, and transmission mediums.

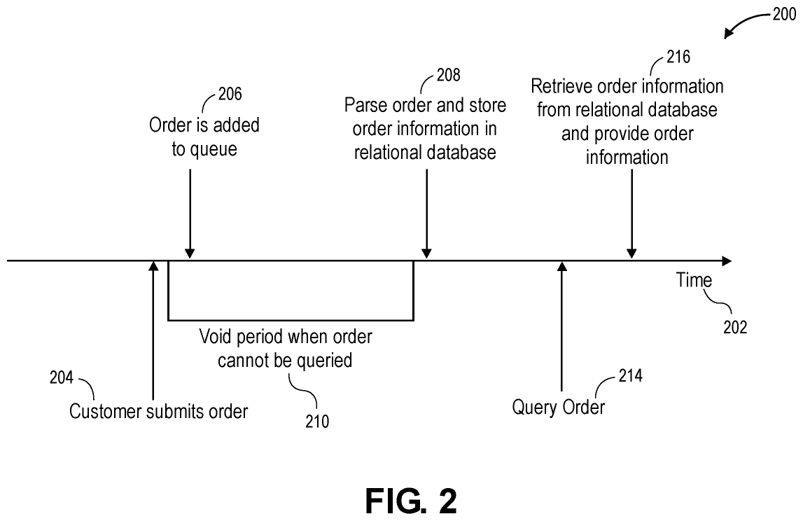

FIG. 2 is an example timeline that shows an example of order processing to illustrate drawbacks associated with conventional order processing systems. The example of order processing is provided by way of illustration and not limitation. One skilled in the art would appreciate that the principles and functions applicable to order processing can also be applied to other type of record, data object, and data item processing. In the illustrated timeline the progression of time is represented by line 202. The operations illustrated below line 202 are performed by client devices, while the operations illustrated above the line 202 are performed by functions of a platform, database system, the on-demand ingestion system, or similar components hosted in a cloud computing environment.

As shown in FIG. 2, when a customer submits an order 204, the order often cannot be processed immediately. Typically, the order is added to a queue 206 (e.g., the staging storage), which is processed by functions of the on-demand ingestion system and/or the database management system. Each entry in the queue can include the payload of a corresponding order. The orders added to the queue can be indexed to be searchable. As the orders in the queue are processed, the on-demand ingestion system obtains the payload of the next order in the queue. The on-demand ingestion system parses the payload of the orders to obtain order information including a plurality of data items, perform validation processes on select data items, generate an order identifier, and store the order information in association with the order identifier in a relational database (i.e., the primary database) after the order has been successfully validated. In addition, the order identifier can be transmitted to the customer to confirm that the order was successfully submitted.

Relational databases (i.e., the primary database) are used to store data such as order information since they provide efficient means of querying orders. However, writing to a traditional relational database is a time-consuming process and is taxing on the database CPU, which is a shared resource. Therefore, delays may impact multiple users of the database system such as multiple tenants supported by a multi-tenant database implementation.

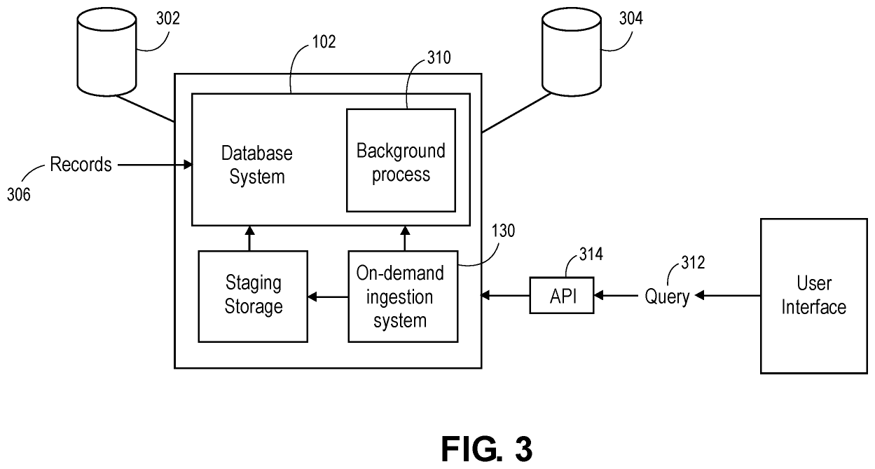

FIG. 3 shows an example of an on-demand ingestion system and database system having a non-relational database and a relational database, in accordance with some implementations. As shown in this example, database system 102 includes a staging storage 302 that is not a relational database and a primary database 304 that is a relational database. For example, staging storage 302 may include an in-memory database. Data store 302 is highly available and maintains data in the event of a power failure. Data store 302 can include two or more data stores that provide redundancy, eliminating points of failure.

A record 306 that is submitted is processed by the database system 102 and/or the on-demand ingestion system 130. The database system 102 or the on-demand ingestion system 130 can store minimally formatted record 306 data (e.g., associated with an order or similar data) in association with an identifier in staging storage 302. The database system 102 and/or the on-demand ingestion system 130 can index the received records or similarly parse and process the received records to facilitate search based on indexed fields or data items in the records 306. Subsequently, the on-demand ingestion system 130 can retrieve the records 306 from staging storage 302 and process related requests to store record information and associated identification information in the primary database 304. The database system 102 and/or the on-demand ingestion system 130 can perform various validation processes on the records. In addition, the database system 102 and/or the on-demand ingestion system 130 can delete records 306 from staging storage 302 after the corresponding order information has been stored in primary database 304.

In some implementations, the database system 102 and/or on-demand ingestion system 130 utilize background process 310 to process records in the staging storage 302 to store associated order information into primary database 304. In addition, background process 310 can be utilized to search, modify, or delete records 306 from staging storage 302 in response to requests from the users or applications external to the database system 102 or after corresponding record information has been stored in the primary database 304.

When a query 312 or similar request is submitted for records 306 via an API 314, a the on-demand ingestion system 130 can process the query 312 or request. The query or request can include the record identifier to enable location of the requested record information. For example, the on-demand ingestion system 130 can query staging storage 302 to determine whether the record associated with the record identifier or similar identifying information (e.g., search criteria) is in staging storage 302. The on-demand ingestions system 130 accesses the records from staging storage 302 if it has determined that an entry including the record identifier or that matches the search criteria is in the staging storage 302. Alternatively, the on-demand ingestion system 130 can access corresponding record information from the primary database 304 if the records 306 have been ingested or after an ingestion of the records 306 at the direction of the on-demand ingestion system 130 in response to a request from a user or application via the API 314 or similar interface.

In some implementations, the on-demand ingestion system 130 can utilize a data structure such as a cache that stores record identifiers to track the records in the staging storage 302. The data structure can also be utilized to store indexing information on the other fields or data items of each record in the staging storage 302 that are searchable. Subsequently, the on-demand ingestion system 130 can retrieve records 306 from staging storage 302 and parse records 306 to store record information and associated record identifiers in the primary database 304.

In some implementations, the records can be received or stored in a Javascript Object Notation (JSON) format, or similar data format. A JSON or similar data format can be utilized for a low resource process of storing the received records into a file or other data structure in the staging storage 302. A record can be in a form of a data object and/or include one or more data items, which can each be defined by one or more fields and/or one or more additional data items. The relationship between data items can be complex. As a result, when a record is parsed, it is often desirable to temporarily store the record and/or the data items in a data structure such as a tree or graph according to a data model to facilitate the processing of the record as well as the indexing and search of the records.

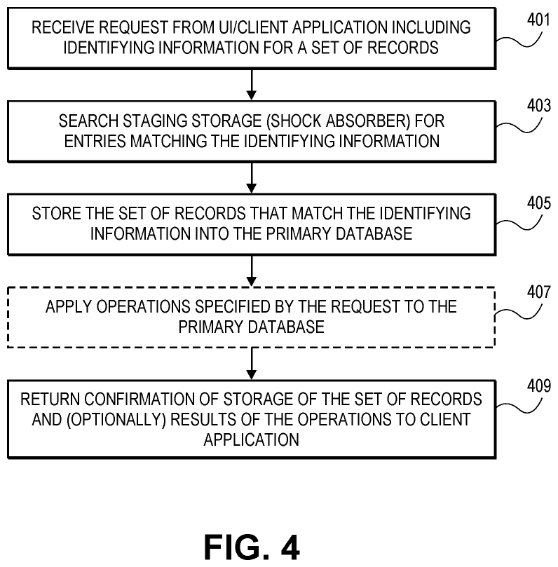

FIG. 4 is a flowchart of a process of an on-demand ingestion system to locate and ingest a set of records in response to a user or application request. The process can be triggered by a user or application sending a request to ingest a set of records to the on-demand ingestion system (Block 401). The request can have any format or contents. In some implementations, the request can specify an ingestion operation and an identifier for the set or records. In other implementations, the request can include search criteria for locating the records, such as a search for all records with a particular user name or address. In response to receiving the request, the on-demand ingestion system searches the staging storage to locate each of the records that match the identifier or the search criteria (Block 403). Each of the matching records can be retrieved and sent or forwarded directly to the primary database and/or database system to be ingested (Block 405). The ingestion of the identified records occurs out of turn from the normal processing of the records in the staging storage. For example, if the staging storage utilizes a first in first out (FIFO) process for records in the staging storage, then the ingestion request moves the identified records to the front of the FIFO queue to be ingested next without waiting for other records to be ingested.

In some implementations, the ingestion request can also specify other operations to perform on the identified set of records (Block 407). For example, the request can specify modifications to certain fields of the records, or an update of certain values of the records. In some implementations, the operations can specify how the records are to be stored in the primary database or how they are shared with other applications. Once the operations and the ingestion has completed, the on-demand ingestion system can send a confirmation that the set of records have been ingested to the requestor (e.g., a user or application) (Block 409). The confirmation can include a record identifier, a confirmation identifier, or similar information to verify that the ingestion has occurred.

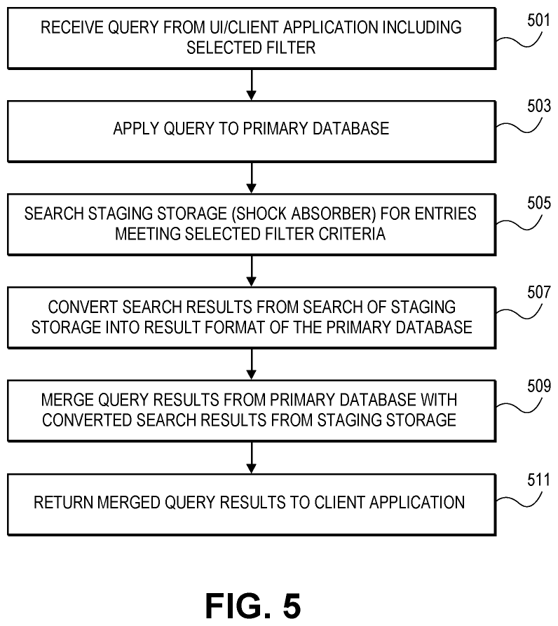

FIG. 5 is a flowchart of one embodiment of a process for processing a query of the records in the staging storage by the on-demand ingestion system. The process of querying the records can be triggered in response to receiving a query from a user or application (Block 501). In some implementations, the on-demand ingestion system can apply the query to the primary database (Block 503). The results of the query on the primary database can be collected while the staging storage is searched based on the query for entries that meet a set of search criteria identified in the query (Block 505). In some implementations, the set of search criteria can be selected from a set of pre-configured options that correlate to the indexing of the records in the staging storage.

The search criteria are matched against the records and indexing for the staging storage. The search results can be converted into a result format of queries for the primary database (Block 507). The query results from primary database and the search results of the staging storage can then be merged with the format of the query results utilized as the final format (Block 509). The result can then be returned to the requesting user or application (Block 511).

Example Electronic Devices and Environments

Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

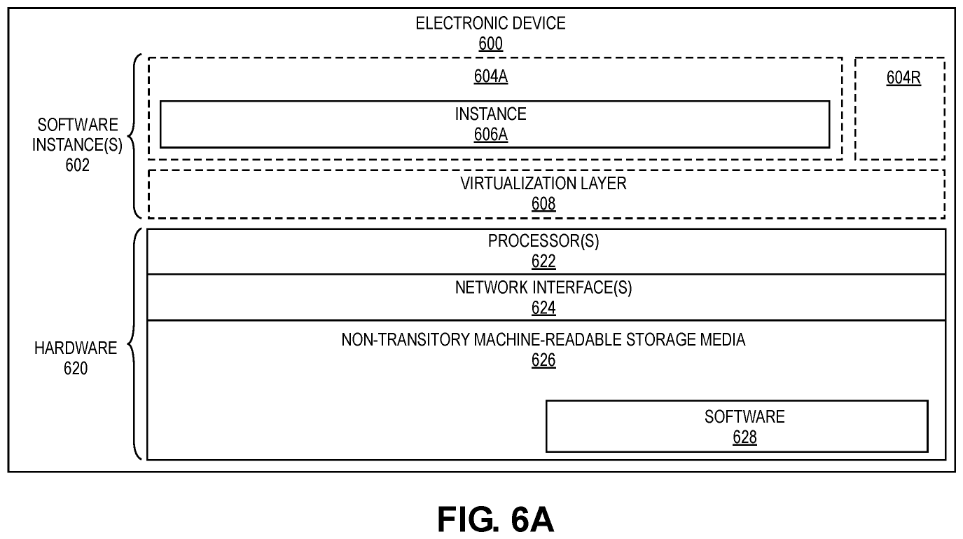

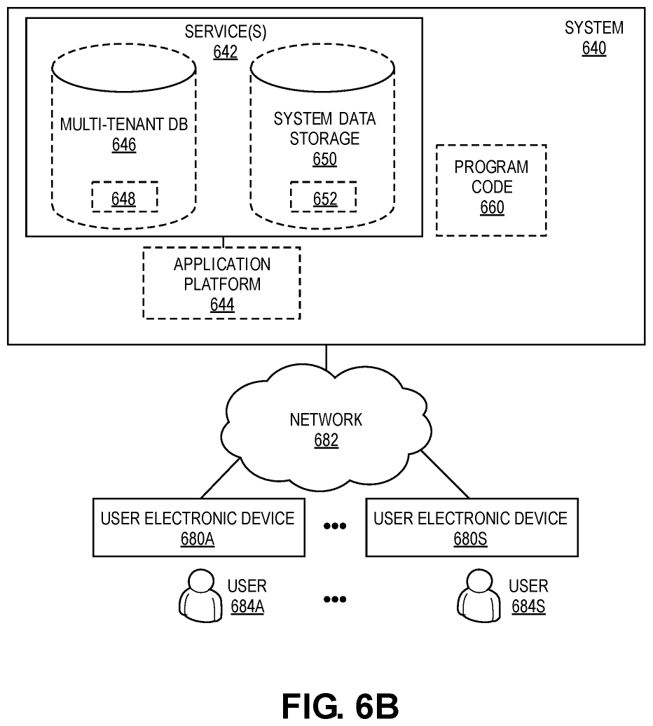

FIG. 6A is a block diagram illustrating an electronic device 600 according to some example implementations. FIG. 6A includes hardware 620 comprising a set of one or more processor(s) 622, a set of one or more network interfaces 624 (wireless and/or wired), and machine-readable media 626 having stored therein software 628 (which includes instructions executable by the set of one or more processor(s) 622). The machine-readable media 626 may include non-transitory and/or transitory machine-readable media. Each of the previously described clients and the on-demand ingestion service may be implemented in one or more electronic devices 600. In one implementation: 1) each of the clients is implemented in a separate one of the electronic devices 600 (e.g., in end user devices where the software 628 represents the software to implement clients to interface directly and/or indirectly with the on-demand ingestion service (e.g., software 628 represents a web browser, a native client, a portal, a command-line interface, and/or an application programming interface (API) based upon protocols such as Simple Object Access Protocol (SOAP), Representational State Transfer (REST), etc.)); 2) the on-demand ingestion service is implemented in a separate set of one or more of the electronic devices 600 (e.g., a set of one or more server devices where the software 628 represents the software to implement the on-demand ingestion service); and 3) in operation, the electronic devices implementing the clients and the on-demand ingestion service would be communicatively coupled (e.g., by a network) and would establish between them (or through one or more other layers and/or or other services) connections for submitting ingestion requests to the on-demand ingestion service and returning confirmations and/or record identifiers to the clients. Other configurations of electronic devices may be used in other implementations (e.g., an implementation in which the client and the on-demand ingestion service are implemented on a single one of electronic device 600).

During operation, an instance of the software 628 (illustrated as instance 606 and referred to as a software instance; and in the more specific case of an application, as an application instance) is executed. In electronic devices that use compute virtualization, the set of one or more processor(s) 622 typically execute software to instantiate a virtualization layer 608 and one or more software container(s) 604A-604R (e.g., with operating system-level virtualization, the virtualization layer 608 may represent a container engine (such as Docker Engine by Docker, Inc. or rkt in Container Linux by Red Hat, Inc.) running on top of (or integrated into) an operating system, and it allows for the creation of multiple software containers 604A-604R (representing separate user space instances and also called virtualization engines, virtual private servers, or jails) that may each be used to execute a set of one or more applications; with full virtualization, the virtualization layer 608 represents a hypervisor (sometimes referred to as a virtual machine monitor (VMM)) or a hypervisor executing on top of a host operating system, and the software containers 604A-604R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 628 is executed within the software container 604A on the virtualization layer 608. In electronic devices where compute virtualization is not used, the instance 606 on top of a host operating system is executed on the “bare metal” electronic device 600. The instantiation of the instance 606, as well as the virtualization layer 608 and software containers 604A-604R if implemented, are collectively referred to as software instance(s) 602.

Alternative implementations of an electronic device may have numerous variations from that described above. For example, customized hardware and/or accelerators might also be used in an electronic device.

Example Environment

FIG. 6B is a block diagram of a deployment environment according to some example implementations. A system 640 includes hardware (e.g., a set of one or more server devices) and software to provide service(s) 642, including the on-demand ingestion service. In some implementations the system 640 is in one or more datacenter(s). These datacenter(s) may be: 1) first party datacenter(s), which are datacenter(s) owned and/or operated by the same entity that provides and/or operates some or all of the software that provides the service(s) 642; and/or 2) third-party datacenter(s), which are datacenter(s) owned and/or operated by one or more different entities than the entity that provides the service(s) 642 (e.g., the different entities may host some or all of the software provided and/or operated by the entity that provides the service(s) 642). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 640 is coupled to user devices 680A-680S over a network 682. The service(s) 642 may be on-demand services that are made available to one or more of the users 684A-684S working for one or more entities other than the entity which owns and/or operates the on-demand services (those users sometimes referred to as outside users) so that those entities need not be concerned with building and/or maintaining a system, but instead may make use of the service(s) 642 when needed (e.g., when needed by the users 684A-684S). The service(s) 642 may communicate with each other and/or with one or more of the user devices 680A-680S via one or more APIs (e.g., a REST API). In some implementations, the user devices 680A-680S are operated by users 684A-684S, and each may be operated as a client device and/or a server device. In some implementations, one or more of the user devices 680A-680S are separate ones of the electronic device 600 or include one or more features of the electronic device 600.

In some implementations, the system 640 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 640 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM).

For example, system 640 may include an application platform 644 that enables PAAS for creating, managing, and executing one or more applications developed by the provider of the application platform 644, users accessing the system 640 via one or more of user devices 680A-680S, or third-party application developers accessing the system 640 via one or more of user devices 680A-680S.

In some implementations, one or more of the service(s) 642 may use one or more multi-tenant databases 646, as well as system data storage 650 for system data 652 accessible to system 640. In certain implementations, the system 640 includes a set of one or more servers that are running on server electronic devices and that are configured to handle requests for any authorized user associated with any tenant (there is no server affinity for a user and/or tenant to a specific server). The user devices 680A-680S communicate with the server(s) of system 640 to request and update tenant-level data and system-level data hosted by system 640, and in response the system 640 (e.g., one or more servers in system 640) automatically may generate one or more Structured Query Language (SQL) statements (e.g., one or more SQL queries) that are designed to access the desired information from the multi-tenant database(s) 646 and/or system data storage 650.

In some implementations, the service(s) 642 are implemented using virtual applications dynamically created at run time responsive to queries from the user devices 680A-680S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 660 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 644 includes an application setup mechanism that supports application developers' creation and management of applications, which may be saved as metadata by save routines. Invocations to such applications, including the on-demand ingestion service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 682 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 640 and the user devices 680A-680S.

Each user device 680A-680S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 640. For example, the user interface device can be used to access data and applications hosted by system 640, and to perform searches on stored data, and otherwise allow one or more of users 684A-684S to interact with various GUI pages that may be presented to the one or more of users 684A-684S. User devices 680A-680S might communicate with system 640 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 680A-680S might include an HTTP client, commonly referred to as a “browser,” for sending and receiving HTTP messages to and from server(s) of system 640, thus allowing users 684A-684S of the user devices 680A-680S to access, process and view information, pages and applications available to it from system 640 over network 682.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A method of a data manager for a database management system having a primary database and a staging storage, the method comprising:
receiving a request including identifying information for a set of records that have been sent to the database management system for storage;
searching the staging storage for the set of records using the identifying information; and
storing the set of records into the primary database prior to a scheduled storage for the set of records based on a general process for ingesting records sent to the database management system for storage in the primary database, in response to the request and to the set of records matching the identifying information.

2. The method of claim 1, wherein the request identifies an operation to perform on the set of records, the method further comprising:
applying the operation to the set of records in the primary database; and
returning confirmation of the storage of the set of records and a result of the operation.

3. The method of a claim 1, the method further comprising:
receiving a query from a client application, the query including a selected filter;
searching a staging storage for entries that match the selected filter;
applying the query to a primary database; and
returning a query result that includes data from the staging storage and the primary database.

4. The method of claim 1, further comprising:
storing search results from the staging storage into the primary database prior to the applying the query to the primary database.

5. The method of claim 1, further comprising:
converting search results from the staging storage into a result format of the primary database; and
merging converted search results with query results from the primary database.

6. The method of claim 1, wherein data in the staging storage is in a file with each entry indexed and serialized.

7. The method of claim 1, wherein the primary database is managed by a relational database management system that can process structured query language (SQL) queries to access the data in the primary database.

8. The method of claim 1, further comprising:
extracting searchable fields of data received and stored in the staging storage where the searchable fields are utilized for indexing the data.

9. The method of claim 1, wherein the selected filter is user defined and shared with the query manager to implement indexing for the fields required by the selected filter.

10. A non-transitory machine-readable storage medium that provides instructions that, if executed by a set of one or more processors, are configurable to cause the set of one or more processors to perform operations of a method of a data manager for a database management system having a primary database and a staging storage, the operations comprising:
receiving a request including identifying information for a set of records;
searching the staging storage for the set of records using the identifying information; and
storing the set of records into the primary database, in response to the set of records matching the identifying information.

11. The non-transitory machine readable medium of claim 10, wherein the request identifies an operation to perform on the set of records, the operations further comprising:
applying the operation to the set of records in the primary database; and
returning confirmation of the storage of the set of records and a result of the operation.

12. The non-transitory machine readable medium of claim 10, the operations comprising:
receiving a query from a client application, the query including a selected filter;
searching a staging storage for entries that match the selected filter;
applying the query to a primary database; and
returning a query result that includes data from the staging storage and the primary database.

13. The non-transitory machine-readable storage medium of claim 10, wherein the set of one or more processors are further configurable to further comprising:
storing search results from the staging storage into the primary database prior to the applying the query to the primary database.

14. The non-transitory machine-readable storage medium of claim 10, wherein the set of one or more processors are further configurable to further comprising:
converting search results from the staging storage into a result format of the primary database; and
merging converted search results with query results from the primary database.

15. The non-transitory machine-readable storage medium of claim 10, wherein data in the staging storage is in a file with each entry indexed and serialized.

16. The non-transitory machine-readable storage medium of claim 10, wherein the primary database is managed by a relational database management system that can process structured query language (SQL) queries to access the data in the primary database.

17. The non-transitory machine-readable storage medium of claim 10, wherein the set of one or more processors are further configurable to further comprising:
extracting searchable fields of data received and stored in the staging storage where the searchable fields are utilized for indexing the data.

18. The non-transitory machine-readable storage medium of claim 10, wherein the selected filter is user defined and shared with the query manager to implement indexing for the fields required by the selected filter.

19. An apparatus comprising:
a non-transitory machine-readable storage medium that stores software; and
a set of one or more processors, coupled to the non-transitory machine-readable storage medium, to execute the software that implements a data manager service for a database management system having a primary database and a staging storage, and that is configurable to:
receiving a request including identifying information for a set of records;
searching the staging storage for the set of records using the identifying information; and
storing the set of records into the primary database, in response to the set of records matching the identifying information.

20. The apparatus of claim 19, wherein the request identifies an operation to perform on the set of records, the set of one or more processors method configurable to:
applying the operation to the set of records in the primary database; and
returning confirmation of the storage of the set of records and a result of the operation.

21. The apparatus of claim 19, wherein the request identifies an operation to perform on the set of records, the set of one or more processors method configurable to:
receive a query from a client application, the query including a selected filter, search a staging storage for entries that match the selected filter,
apply the query to a primary database, and
return a query result that includes data from the staging storage and the primary database.

22. The apparatus of claim 19, wherein the query management service is further configure to:
store search results from the staging storage into the primary database prior to the applying the query to the primary database.

23. The apparatus of claim 19, wherein the query management service is further configure to:
converting search results from the staging storage into a result format of the primary database; and
merging converted search results with query results from the primary database.

24. The apparatus of claim 19, wherein data in the staging storage is in a file with each entry indexed and serialized.

25. The apparatus of claim 19, wherein the primary database is managed by a relational database management system that can process structured query language (SQL) queries to access the data in the primary database.

26. The apparatus of claim 19, further comprising:
extracting searchable fields of data received and stored in the staging storage where the searchable fields are utilized for indexing the data.

27. The apparatus of claim 19, wherein the selected filter is user defined and shared with the query manager to implement indexing for the fields required by the selected filter.
